(19) United States
(12) Patent Application Publication
(10) Pub. No.: US 2008/0025024 A1
(43) Pub. Date: Jan. 31, 2008

(54) PARALLEL-SERIES LED LIGHT STRING

(76) Inventor: JINGJING YU, Vancouver (CA)

Correspondence Address: COCHRAN FREUND & YOUNG LLC, 2026 CARIBOU DR, SUITE 201, FORT COLLINS, CO, 80525, US

(21) Appl. No.: 11/461,293

(22) Filed: Jul. 31, 2006

(51) Int. Cl. F21S 13/14

(52) U.S. Cl. 362/252

(57) ABSTRACT

Disclosed is a LED light string that uses parallel connected resistors that are connected across the leads of the LEDs in a light string and are disposed in the socket of the LED lamp holder. The use of parallel connected resistors across the leads of the LEDs greatly enhances the reliability of the light string.

### BACKGROUND

Late emitting diodes (LEDs) have been widely used as decorative lighting sources because of their physical properties, such as low power consumption, small size and extended lifetime. The market for decorative LED light strings is large.

Currently, most of the conventional LED light strings use a serial structure such as illustrated in FIG. 1 in which of the LEDs 102, 104, 106, 108, 110, 112 are connected in series as shown in the series wired LED string 100 of FIG. 1. The series wired LED string 100 comprises a circuit having an input 114 and output 116. There are three wires that span the length of the string in the circuit of FIG. 1. This structure is also disclosed in U.S. Pat. Nos. 6,461,019 and 6,830,358 which are specifically incorporated herein by reference for all that they disclose and teach. A problem encountered with the series wired LED string 100 is that if a single LED in the string fails because the LED burns out, becomes unplugged or any other reason that may cause an open circuit, the entire string will fail. In other words, a single failure of a LED in the series wired LED circuit 100 illustrated in FIG. 1 will cause the entire string to fail and not illuminate.

To overcome the disadvantages of the series wired LED structure 100 illustrated in FIG. 1, a parallel-series wired LED string 200 has been used which is disclosed in U.S. Pat. No. 7,045,965, which is specifically incorporated herein by reference for all that it discloses and teaches. As shown in FIG. 2, the circuit has an input 216 and output 218 that includes an upper conductive pair 220 and a lower conductive pair 214. The upper conductive pair includes a wire 202 and a wire 204. The parallel-series wired LED string 200 illustrated in FIG. 2 increases the reliability of the light string 200 in comparison light string 100 of FIG. 1. As shown in FIG. 2, wires 202, 204 are connected in parallel to form two parallel-series strings. Interconnecting wires such as interconnecting wires 210, 212 create individual modules such as the parallel connected modules containing LEDs 206, 208. If one of the LEDs 206, 208 fails, the other LED continues to provide a conductive path in the upper conductive pair 220. For example, if LED 206 fails and creates an open circuit, the conductive path continues through LED 208 in the upper conductive pair 220.

A disadvantage with respect to the circuit illustrated in FIG. 2 is that there are four wires that span the length of the string in the circuit of FIG. 2. Since the cost of the wires is the dominant cost for LED light strings, the competitiveness of the parallel-series wired LED string 200 of FIG. 2 is diminished. Also, if both LEDs in a module burn out or otherwise create an open circuit, the entire string will not illuminate.

### SUMMARY OF THE INVENTION

An embodiment of the present invention may therefore comprise a parallel-series wired light string comprising: a first parallel connector that is connected between an input and an output; a second parallel connector connected between the input and the output; a first resistor that is wired in series in the first parallel connector; a plurality of LED modules wired in series in the first parallel connector, the LED modules comprising: a LED having leads; a LED holder; a second resistor disposed in the LED holder that is wired in parallel with the LED across the leads.

An embodiment of the present invention may further comprise a method of manufacturing a light string comprising: connecting a first parallel connector to an input and an output; connecting a second parallel connector to the input and the output; wiring a resistor in series in the first parallel connector; providing a plurality of LED modules having LED holders with resistors and LEDs disposed in the LED holders; wiring the resistors across leads of the LEDs in parallel with the LEDs; wiring the plurality of LED modules in series in the first parallel connector.

An embodiment of the present invention may further comprise a parallel-series wired light string comprising: a first parallel connector that is connected between an input and an output; a second parallel connector connected between the input and the output; a resistor that is wired in series in the first parallel connector; a plurality of LED modules wired in series in the first parallel connector, the LED modules comprising: a LED having leads and a LED forward breakdown voltage; a LED holder; a diode disposed in the LED holder that is wired in parallel with the LED across the leads, the diode having a diode forward breakdown voltage that is higher than the LED forward breakdown voltage.

An embodiment of the present invention may further comprise a method of manufacturing a light string comprising: connecting a first parallel connector to an input and an output; connecting a second parallel connector to the input and the output; wiring a resistor in series in the first parallel connector; providing a plurality of LED modules having LED holders with diodes and LEDs disposed in the LED holders; wiring the diodes across leads of the LEDs in parallel with the LEDs; wiring the diodes across leads of the LEDs in parallel with the LEDs; wiring the plurality of LED modules in series in the first parallel connector.

### BRIEF DESCRIPTION OF THE DRAWINGS

FIG. 1 is a schematic circuit diagram of a series connected LED string.

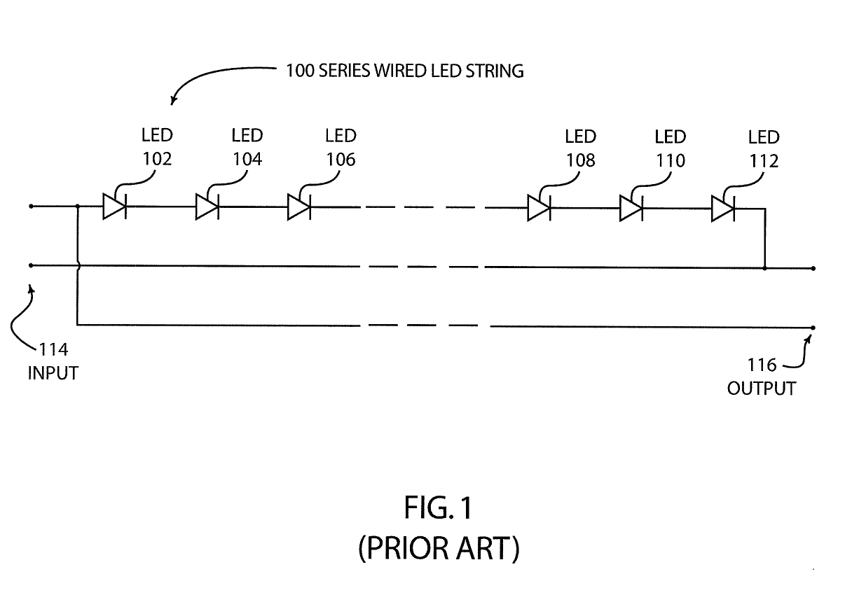

FIG. 2 is a schematic circuit diagram of a parallel-series wired LED string.

FIG. 3 is a schematic circuit diagram of an embodiment of a parallel-series circuit using parallel connected resistors.

FIG. 4 is a schematic illustration of the manner in which a parallel connected resistor can be incorporated in a LED lamp holder.

FIG. 5 is a schematic circuit diagram of another embodiment of a parallel-series circuit using parallel connected diodes.

### DETAILED DESCRIPTION OF THE EMBODIMENTS

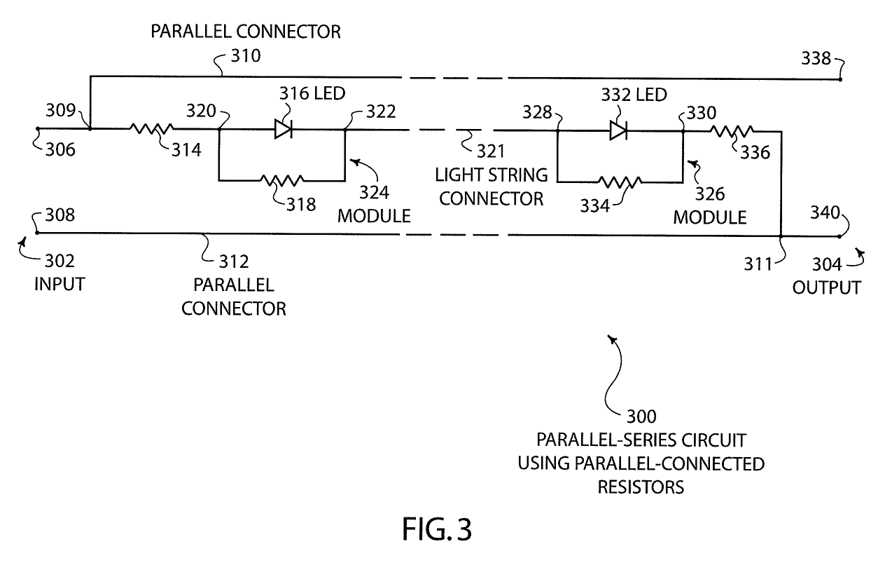

FIG. 3 is a schematic circuit diagram of an embodiment of a parallel-series circuit 300 using parallel connected resistors. Circuit 300 has an input 302 at nodes 306, 308 and an output 304 at nodes 338, 340. The parallel connector 310 includes a series of circuit elements. Resistors 314 and 336 are inserted in series in the connector 310 to ensure sufficient voltage drop between the input 302 and output 304. Only one resistor is required for this purpose, although two resistors are shown. In addition, a plurality of modules, such as modules 324, 326, are connected in series in connector 310. Each module contains a LED and a resistor connected in parallel. For example, module 324 includes a LED 316 which is connected in parallel with a resistor 318. Similarly, module 326 includes a LED 332 that is connected in parallel with a resistor 334.

The parallel connected LED and resistors of each of the modules are packaged together in the lamp holder, such as a lamp socket, during manufacture. In this fashion, the cost of an additional wire is eliminated, thereby substantially reducing the cost of the parallel-series circuit 300, illustrated in FIG. 3. For example, the resistor 318 is connected directly across the LED 316 at nodes 320, 322 that are inside the lamp socket. The direct connection within the lamp socket simplifies the system and minimizes the material cost. Each of the modules included in the light string thereby constitutes a LED with a resistor embedded in the lamp holder that is connected across the terminals of the LED. The resistor can comprise a discrete component or otherwise be included as an integral part of the wiring of the LED lamp holder, such as a resistive wire or other element having resistive characteristics. The resistors can be molded into the plastic holder, if desired, during manufacture or later inserted in the lamp holder and connected to the connector leads in the lamp holder. In addition, the resistors can be pre-wired prior to insertion in the lamp holders.

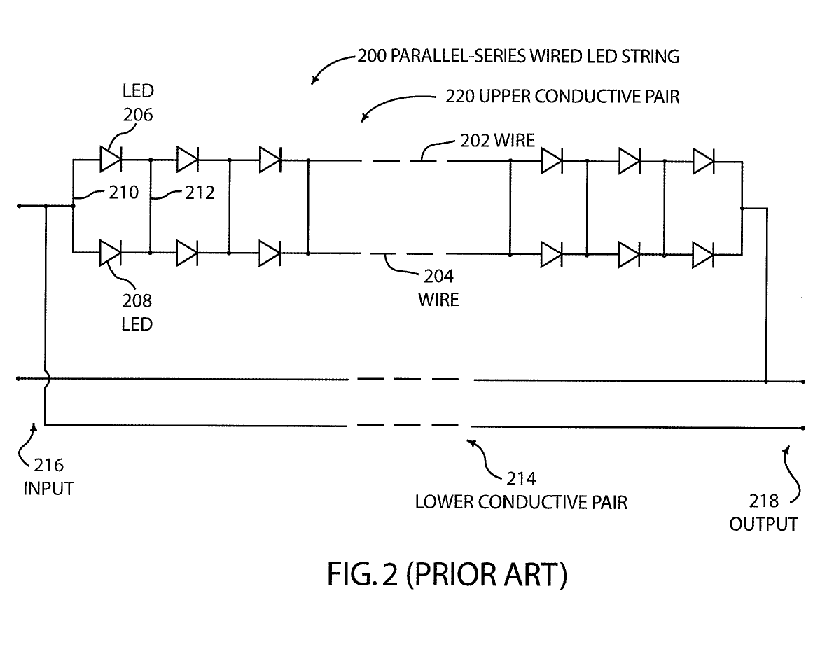

As shown in FIG. 3, a plurality of these modules are connected in series in the light string connector 321 for each light string, such as illustrated in FIG. 3. The light string connector 321 is connected at node 309 to parallel connector 310 near the input 302. The light string connector 321 is connected at node 311 to parallel connector 312 near the output 304. In this manner, the light string connector 321 essentially spans the length between the input 302 and the output 304 so that the modules are displaced along the length of the parallel-series circuit 300. As indicated above, if any of the LEDs in the light string, such as LEDs 316, 332 go out, the continuity in light string connector 321 is maintained by the parallel connected resistors. When comparing the embodiment of FIG. 3 to the embodiment of FIG. 2, the embodiment of FIG. 2 has an additional wire spanning the length of the light string, plus the additional cost of the interconnecting wires, such as wires 210, 212. The embodiment of FIG. 3 has the advantage of providing the reliability of the circuit of FIG. 2, without the cost of an additional wire. Further, if one of the LEDs of the embodiment of FIG. 3 goes out, not only is the continuity of the light string connector 321 maintained, but in addition, the parallel connected resistors, such as parallel connected resistors 314, 336, further enhances the reliability of the embodiment circuit of FIG. 3 over the circuit of FIG. 2 since the parallel connected resistors are much less likely to burn out than the parallel connected LEDs of FIG. 2. If the LEDs, such as LEDs 316, 332 are replaceable in a socket, the LEDs that burn out can be readily identified and new ones can simply be plugged into the socket without affecting the overall operation of the circuit 300. If one of the LEDs 316, 332 of FIG. 3 is shorted, that particular module will become shorted. Series connected resistors 318, 336 limit the current sufficiently that an overload condition does not occur on light string connector 321 even if several modules are shorted. Hence, series connected resistors 318, 334 are sized to accommodate the shorting of one, several, or all of the LEDs, such as LEDs 316, 332.

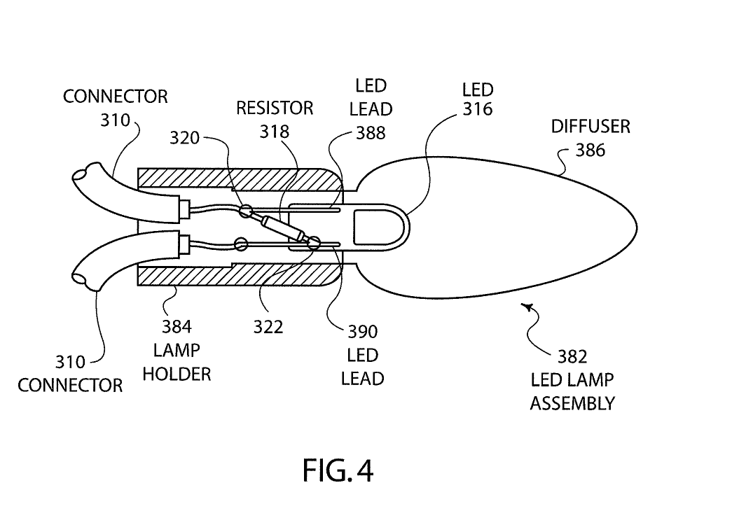

FIG. 4 is a schematic illustration of a LED lamp assembly 382 that corresponds to the module 324 of FIG. 3. As shown in FIG. 4, the LED 316 is housed within a diff-user 386 that diffuses the light emitted by the LED 316. The LED 316 is disposed within the lamp holder 384 which may be made of a plastic material. Connector 310 is disposed within another opening in the lamp holder 384 and is connected at nodes 320, 322 to the leads 388, 390 of the LED 316. The resistor 318 is also connected across the leads 388, 390 of the LED 316 at nodes 338, 340 to place the resistor 318 in parallel with the leads of LED 316. In this manner, the reliability of the light string can be greatly enhanced without substantially increasing the cost over a standard series connected light string.

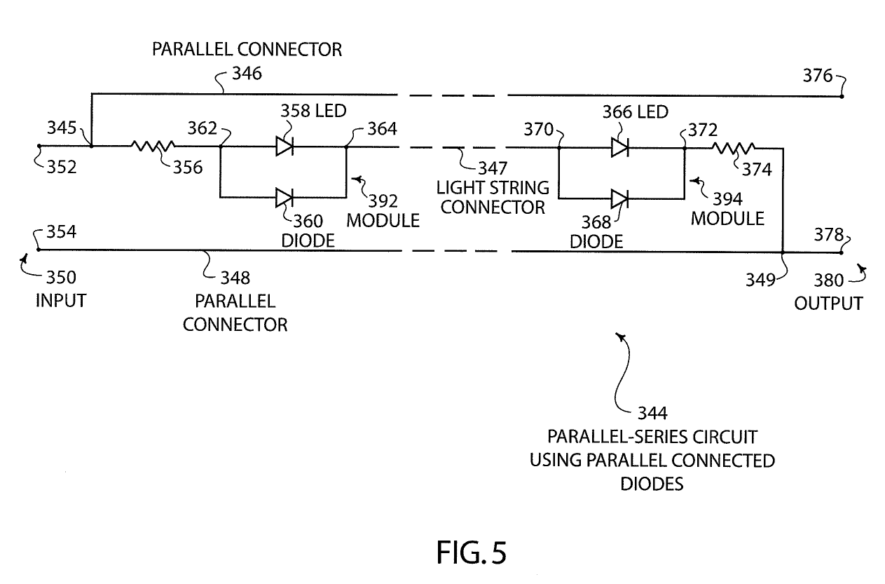

FIG. 5 is an illustration of another embodiment. FIG. 5 illustrates a parallel-series connected circuit 344 that uses parallel connected diodes. The circuit 344 includes an input 350 having nodes 352, 354. The input nodes 352, 354 are connected to parallel connector 346 and parallel connector 348. Parallel connector 346 is also connected to an output 380 at node 376. Parallel connector 348 is connected to the output 380 at node 378. Light string connector 347 is connected to the parallel connector 346 at node 345 which is proximate to the input 350. In addition, light string connector 347 is connected to parallel connector 348 at node 349 which is proximate to the output 380. In this fashion, the light string connector 347 essentially spans the length of the parallel-series circuit 344. Input 350 may comprise a plug for plugging the circuit 344 into a 117 volt RMS AC current source. The output nodes 376, 378 may be connected to a socket so that additional light strings may be connected in series with the light string circuit 344 illustrated in FIG. 5.

As shown in FIG. 5, resistors 356, 374 are connected in series in the light string connector 347 to limit the current flowing through parallel connector 346. Although parallel connector 346 includes two resistors 356, 374, a single resistor can be used in place of two resistors. In addition, a plurality of modules, such as modules 392, 394, are connected in series in the light string connector 347. Each of these modules includes a parallel connected LED and diode. For example, module 392 includes a LED 358 that is connected in parallel with a diode 360. The LED 358 is held in a lamp holder, such as a plastic lamp holder 384, illustrated in FIG. 4. Diode 360 can be connected across the leads of the LED 358, in the same manner as resistor 318 is connected across the leads of LED 316 illustrated in FIG. 4 and can be disposed in the lamp holder. The connection of diode 360 across the leads of the LED 358 at nodes 362, 364 reduces the material cost of the circuit 344 and greatly increases the reliability of the circuit 344. Diode 360 has a forward breakdown voltage that is higher than the LED 358 so that the LED 358 is not shorted out by the diode 360. Hence, the current flowing through light string connector 347 preferentially travels through the LED 358 which has a lower breakdown voltage than diode 360. Similarly, module 394 has a diode 368 that is connected across the leads of LED 366 at nodes 370, 372. Diode 368 also has a higher breakdown voltage than LED 366 so that current preferentially flows through LED 366. Of course, if LED 358 burns out and creates an open circuit, current will flow through diode 360 since the forward breakdown voltage will be exceeded.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A series wired light string comprising:
a first parallel connector that is connected between an input and an output;
a second parallel connector connected between said input and said output;
a light string connector that is connected to said first parallel connector at a first node near said input and that is connected to a second parallel connector at a second node near said output;
a plurality of LED modules wired in series in said light string connector, said LED modules comprising:
a LED having leads;
a lamp holder;
a bypass component disposed in said LED holder that is wired in parallel with said LED across said leads.

2. The light string of claim 1 wherein said bypass component is a discrete component.

3. The light string of claim 2 wherein said bypass component is further comprising an additional resistor that is connected in series in said light string connector.

4. The light string of claim 3 wherein said input comprises a plug and said output comprises a socket.

5. A method of manufacturing a light string comprising:
connecting a first parallel connector to an input and an output;
connecting a second parallel connector to said input and said output;
connecting a light string connector to said first parallel connector near said input;
connecting said light string connector to said second parallel connector near said output;
providing a plurality of LED modules having LED holders with resistors and LEDs disposed in said LED holders;
wiring said resistors across leads of said LEDs in parallel with said LEDs;
wiring said plurality of LED modules in series in said light string connector.

6. The method of claim 5 farther comprising:
providing said input as a plug;
providing said output as a socket.

7. The method of claim 6 further comprising:
wiring an additional resistor in series in said light string connector.

8. A parallel-series wired light string comprising:
a first parallel connector that is connected between an input and an output;
a second parallel connector connected between said input and said output;
a light string connector that is connected to said parallel connector at a first node near said input and that is connected to a second parallel connector at a second node near said output;
a first resistor that is wired in series in said light string connector;
a plurality of LED modules that are wired in series in said light string connector, said LED modules comprising:
a LED having leads and a LED forward breakdown voltage;
a LED holder;
a diode disposed in said LED holder that is wired in parallel with said LED across said leads, said diode having a diode forward breakdown voltage that is higher than said LED forward breakdown voltage.

9. The light string of claim 8 wherein said input comprises a plug and said output comprises a socket.

10. The light string of claim 9 further comprising:
a resistor that is wired in series in said light string connector.

11. A method of manufacturing a light string comprising:
connecting a first parallel connector to an input and an output;
connecting a second parallel connector to said input and said output;
connecting a light string connector to said first parallel connector near said input;
connecting said light string connector to said second parallel connector near said output;
providing a plurality of LED modules having LED holders with diodes and LEDs disposed in said LED holders;
wiring said diodes across leads of said LEDs in parallel with said LEDs;
wiring said plurality of LED modules in series in said first parallel connector.

12. The method of claim 11 further comprising:
providing said input as a plug;
providing said output as a socket;
wiring an additional resistor in series in said light string connector.
